(19) United States
(12) Patent Application Publication
(10) Pub. No.: US 2008/0020300 A1
(43) Pub. Date: Jan. 24, 2008

(54) Photosensitive Resin Composition for Color Filter of Image Sensor and Color Filter of Image Sensor Using the Same

(75) Inventors: Kil Sung LEE, Gwacheon-si (KR); Jae Hyun Kim, Seongnam-si (KR); Chang Min Lee, Goyang-si (KR); Eui Jun Jeong, Seoul (KR); Hee Young Kim, Anyang-si (KR); Jee Yun Kim, Seoul (KR); Gyung Hoon Choo, Seoul (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: Cheil Industries Inc.

(21) Appl. No.: 11/617,012

(22) Filed: Dec. 28, 2006

(30) Foreign Application Priority Data
Jul. 18, 2006 (KR) 10-2006-0066818

(51) Int. Cl. G02B 5/20

(52) U.S. Cl. 430/7; 430/281.1

(57) ABSTRACT

A photosensitive resin composition for a color filter of an image sensor is disclosed. The photosensitive resin composition is developable with an aqueous alkaline solution. The photosensitive resin composition can include (a) an acrylic resin, (b) a photopolymerizable acrylic monomer, (c) a photopolymerization initiator, (d) a pigment dispersion and (e) a solvent wherein the acrylic resin is a copolymer of ethylenically unsaturated monomers and contains 10 to 40 mole % of an ethylenically unsaturated monomer having a carboxyl group. Since the photosensitive resin composition can enable the formation of ultra-fine pixels, it can be used to produce color filters of high-resolution image sensors.

### FIELD OF THE INVENTION

The present invention relates to a photosensitive resin composition for a color filter of an image sensor.

### BACKGROUND OF THE INVENTION

Image sensors are devices that consist of several million photovoltaic devices. Image sensors receive light and convert the light to electrical signals corresponding to the intensity of the light. Such image sensors are used in digital input devices to enable conversion of images prior to digitalization to digital images. With recent rapid developments in technologies, there has been exponentially increased demand for image sensors for use in various security systems and digital cameras.

Image sensors comprise an array of pixels, that is, a plurality of pixels arrayed in a two-dimensional matrix form, each of which includes a photodetector and transmission/signal output devices. Image sensors are typically divided into two types, i.e. charge coupled device (CCD) image sensors and complementary metal oxide semiconductor (CMOS) image sensors, depending on the kind of transmission/signal output devices used in the image sensors.

The structure of a CMOS image sensor is schematically shown in FIG. 1. A color filter of the image sensor functions to separate externally incident light into red (R), green (G) and blue (B) light components and transmit the separated components to respective photodiodes corresponding to pixels.

Extensive research and development have been conducted on photosensitive resin compositions for color filters of liquid crystal displays which are developable with aqueous alkaline solutions. Few studies have been done to develop photosensitive resin compositions for color filters of image sensors.

A recent approach to achieve improved image quality of image processing devices, particularly, digital cameras, is to decrease the length of one side of pixels from 3-5 μm down to 1 μm. Under such circumstances, significant improvements of pixel materials are required.

Color filters of image sensors and production methods thereof have hitherto been described in many patent publications (for example, KR 2002-039125, JP Hei 10-066094, KR 1998-056215, JP Hei 7-235655, KR 2003-056596, JP 2005-278213, KR 2003-002899, and JP Hei 11-354763). Patent publications concerning compositions for color filters of image sensors include Korean Patent Laid-open No. 2006-0052171 and Japanese Unexamined Patent Publication Nos. 2004-341121 and Hei 9-021910.

Korean Patent Laid-open No. 2006-0052171 and Japanese Unexamined Patent Publication No. 2004-341121 are directed to methods for the formation of a pattern having a size of about 2.0 μm×2.0 μm. These methods are characterized in that dyes are used as colorants, instead of pigments, to form high-density pixels. However, since the dyes are highly susceptible to light and heat, which are inherent characteristics of dyes, the fine pixels suffer from poor long-term reliability. Although the patent publications state that the dyes had ensured heat resistance and light resistance, data associated with the characteristics of the dyes were obtained through experiments for one hour to a maximum of 20 hours, thus causing limited reliability. Japanese Unexamined Patent Publication No. Hei 7-172032 is directed to a method for the formation of fine pixels using a black matrix to prevent color mixing between R, G and B pixels and dislocation of the pixels. A disadvantage of this method is that an additional step is involved to form the black matrix. Other disadvantages are that it is substantially impossible to elaborately form the black matrix and the introduction of the black matrix causes low opening ratio.

### SUMMARY OF THE INVENTION

The present invention can provide a photosensitive resin composition for a color filter which can use an acrylic resin and a pigment dispersion containing the acrylic resin as a dispersant, and which can be used to form ultra-fine pixels.

The present invention can further provide a photosensitive resin composition for a color filter of an image sensor which can include a highly heat-resistant and light-resistant pigment as a colorant and which can be used to form a pattern of ultra-fine pixels whose shape is a square having a size not larger than about 1.0 μm×about 1.0 μm, leaving no residue on unexposed portions.

In accordance with one aspect of the present invention, there is provided a photosensitive resin composition for a color filter which can include (a) an acrylic resin, (b) a photopolymerizable acrylic monomer, (c) a photopolymerization initiator, (d) a pigment dispersion and (e) a solvent wherein the acrylic resin is a copolymer of ethylenically unsaturated monomers and contains about 10 to about 40 mole % of an ethylenically unsaturated monomer having a carboxyl group.

In a specific embodiment of the present invention, the photosensitive resin composition can include (a) about 0.5 to about 20% by weight of the acrylic resin, (b) about 0.5 to about 20% by weight of the photopolymerizable acrylic monomer, (c) about 0.1 to about 10% by weight of the photopolymerization initiator, (d) about 0.1 to about 50% by weight of the pigment dispersion, and (e) the balance of the solvent.

In an embodiment of the present invention, the acrylic resin may be a copolymer consisting of at least one ethylenically unsaturated monomer having a carboxyl group and at least one ethylenically unsaturated monomer as repeating units.

In an exemplary embodiment of the present invention, the ethylenically unsaturated monomer having a carboxyl group can be selected from the group consisting of acrylic acid, methacrylic acid, maleic acid, itaconic acid, and fumaric acid.

In another exemplary embodiment of the present invention, the ethylenically unsaturated monomer can be selected from the group consisting of: styrenes, including styrene, a-methylstyrene, vinyltoluene and vinylbenzyl methyl ether; unsaturated carboxylic acid esters, including methyl acrylate, methyl methacrylate, ethyl acrylate, ethyl methacrylate, butyl acrylate, butyl methacrylate, 2-hydroxyethyl acrylate, 2-hydroxyethyl methacrylate, 2-hydroxybutyl acrylate, 2-hydroxybutyl methacrylate, benzyl acrylate, benzyl methacrylate, cyclohexyl acrylate, cyclohexyl methacrylate, phenyl acrylate and phenyl methacrylate; unsaturated carboxylic acid aminoalkyl esters, including 2-aminoethyl acrylate, 2-aminoethyl methacrylate, 2-dimethylaminoethyl acrylate and 2-dimethylaminoethyl methacrylate; carboxylic acid vinyl esters, including vinyl acetate and vinylbenzoate; unsaturated carboxylic acid glycidyl esters, including glycidyl acrylate and glycidyl methacrylate; vinyl cyanide compounds, including acrylonitrile and methacrylonitrile; and unsaturated amides, including acrylamide and methacrylamide.

In a further embodiment of the present invention, the acrylic resin can be a copolymer of ethylenically unsaturated monomers and may contain about 20 to about 30 mole % of an ethylenically unsaturated monomer having a carboxyl group.

In another embodiment of the present invention, the photopolymerization initiator may be selected from the group consisting of triazine compounds, acetophenone compounds, benzophenone compounds, thioxanthone compounds, and benzoin compounds.

In an exemplary embodiment of the present invention, the photopolymerization initiator can be a triazine compound and may have a maximum absorption wavelength (λₘₐₓ) of about 340 to about 380 nm.

In another exemplary embodiment of the present invention, the triazine compound may be the compound represented by one of the following Formulae 1 to 4:

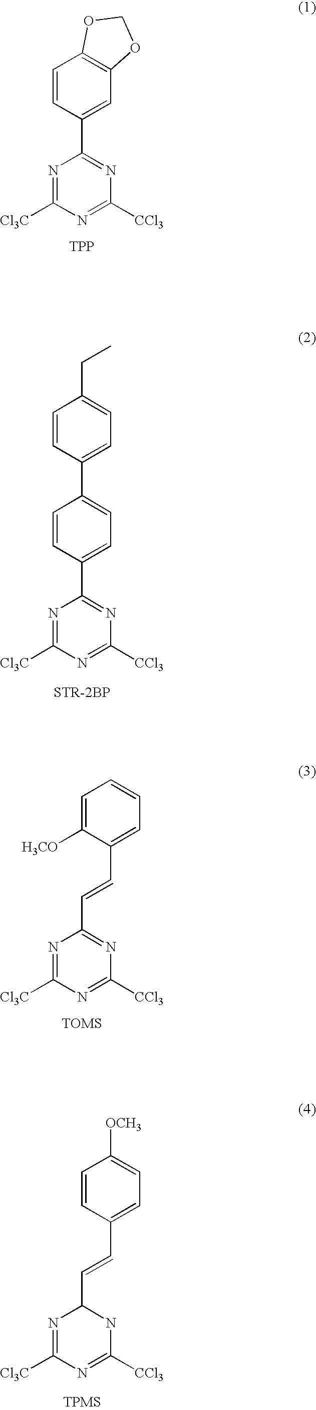

In yet another embodiment of the present invention, the resin composition may further include at least one additive selected from malonic acid, 3-amino-1,2-propanediol, and fluorinated surfactants.

In accordance with another aspect of the present invention, there is provided a color filter of an image sensor which can include a pattern formed using the photosensitive resin composition.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view schematically showing the structure of a CMOS image sensor, which is an exemplary type of an image sensor that can be fabricated using a photosensitive resin composition of the present invention;

FIG. 2 is a photograph of pixels formed using a photosensitive resin composition for a color filter, which is prepared in Example 1 of the present invention; and

FIG. 3 is a photograph of defective pixels formed using a photosensitive resin composition for a color filter, which is prepared in Comparative Example 1 of the present invention.

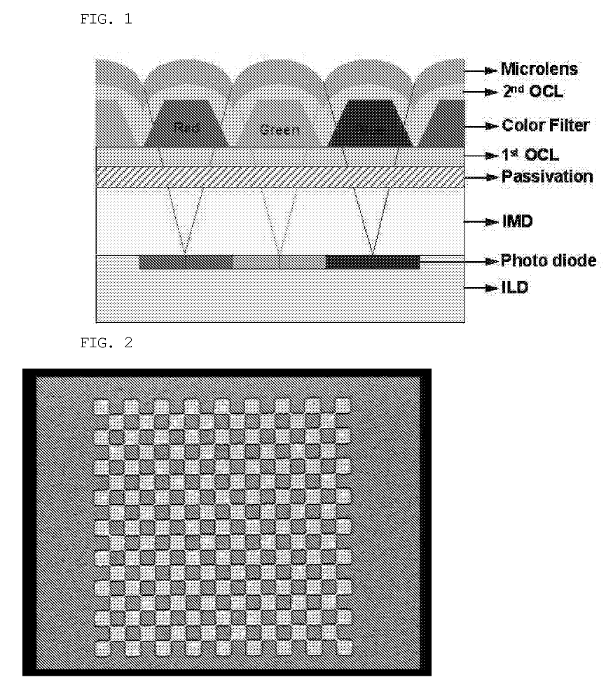

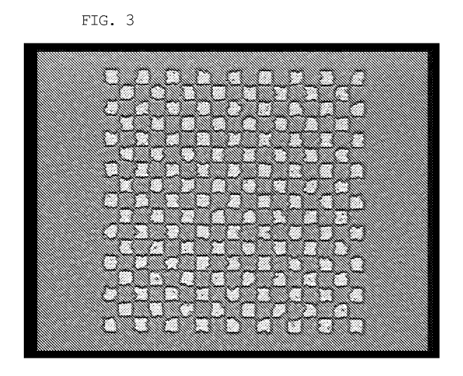

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention provides a photosensitive resin composition for a color filter that can include (a) an acrylic resin, (b) a photopolymerizable acrylic monomer, (c) a photopolymerization initiator, (d) a pigment dispersion and (e) a solvent wherein the acrylic resin is a copolymer of ethylenically unsaturated monomers and contains an ethylenically unsaturated monomer having a carboxyl group as a repeating unit.

The acrylic resin (a) can be a copolymer containing an ethylenically unsaturated monomer having a carboxyl group as an essential repeating unit, as represented by the following chemical structure:

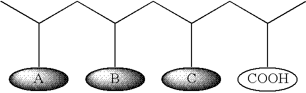

Each of the groups A, B and C of the ethylenically unsaturated monomers, which may be identical to or different from one another, is not a carboxyl group.

The content of the ethylenically unsaturated monomer having a carboxyl group in the acrylic resin (a) can be in the range of about 10 to about 40 mole %, for example about 20 to about 30 mole %, based on the total moles of the copolymer.

The acrylic resin can have a molecular weight (M_{w}) of about 10,000 to about 70,000, for example about 20,000 to about 50,000.

The ethylenically unsaturated monomer having a carboxyl group can be selected from the group consisting of acrylic acid, methacrylic acid, maleic acid, itaconic acid, and fumaric acid. Examples of ethylenically unsaturated monomers that can be copolymerized with the ethylenically unsaturated monomer having a carboxyl group include: styrenes, including styrene, α-methylstyrene, vinyltoluene and vinylbenzyl methyl ether; unsaturated carboxylic acid esters, including methyl acrylate, methyl methacrylate, ethyl acrylate, ethyl methacrylate, butyl acrylate, butyl methacrylate, 2-hydroxyethyl acrylate, 2-hydroxyethyl methacrylate, 2-hydroxybutyl acrylate, 2-hydroxybutyl methacrylate, benzyl acrylate, benzyl methacrylate, cyclohexyl acrylate, cyclohexyl methacrylate, phenyl acrylate and phenyl methacrylate; unsaturated carboxylic acid aminoalkyl esters, including 2-aminoethyl acrylate, 2-aminoethyl methacrylate, 2-dimethylaminoethyl acrylate and 2-dimethylaminoethyl methacrylate; carboxylic acid vinyl esters, including vinyl acetate and vinylbenzoate; unsaturated carboxylic acid glycidyl esters, including glycidyl acrylate and glycidyl methacrylate; vinyl cyanide compounds, including acrylonitrile and methacrylonitrile; and unsaturated amides, including acrylamide and methacrylamide.

Specific examples of the acrylic resin include methacrylic acid/methyl methacrylate, methacrylic acid/benzyl methacrylate, methacrylic acid/benzyl methacrylate/styrene, methacrylic acid/benzyl methacrylate/2-hydroxy ethyl methacrylate, and methacrylic acid/benzyl methacrylate/styrene/2-hydroxy ethyl methacrylate copolymers.

The acrylic resin (a) can be an important factor determining the resolution of pixels. The acrylic resin (a) can be used in an amount of about 0.5 to about 20% by weight, based on the total weight of the final composition. When the component (a) is present in an amount of less than about 0.5% by weight, the composition may not be developed in an alkali developing solution. Meanwhile, when the component (a) is present in an amount exceeding about 20% by weight, the crosslinkability can be poor, which can cause increased surface roughness and poor resolution.

The photopolymerizable acrylic monomer (b) can be one that is generally used to prepare conventional photosensitive resin compositions for color filters. As the photopolymerizable acrylic monomer, there can be used, for example, a monomer selected from the group consisting of ethylene glycol diacrylate, triethylene glycol diacrylate, 1,4-butanediol diacrylate, 1,6-hexanediol diacrylate, neopentyl glycol diacrylate, pentaerythritol diacrylate, pentaerythritol triacrylate, dipentaerythritol diacrylate, dipentaerythritol triacrylate, dipentaerythritol pentaacrylate, pentaerythritol hexaacrylate, bisphenol A diacrylate, trimethylolpropane triacrylate, novolac epoxy acrylate, ethylene glycol dimethacrylate, diethylene glycol dimethacrylate, triethylene glycol dimethacrylate, propylene glycol dimethacrylate, 1,4-butanediol dimethacrylate, and 1,6-hexanediol dimethacrylate, and mixtures thereof.

The photopolymerizable acrylic monomer (b) can be used in an amount of about 0.5 to about 20% by weight, based on the total weight of the final composition. When the photopolymerizable acrylic monomer is used in an amount of less than about 0.5% by weight, edges of pixels to be formed may be irregular. Meanwhile, when the photopolymerizable acrylic monomer is used in an amount of more than about 20% by weight, the composition may not be developed in an alkali developing solution.

The photopolymerization initiator (c) can be one that is generally used to prepare conventional photosensitive resin compositions. As the photopolymerization initiator, there may be used, for example, a compound selected from the group consisting of triazine compounds, acetophenone compounds, benzophenone compounds, thioxanthone compounds, and benzoin compounds.

Specific examples of suitable triazine compounds that can be used as the photopolymerization initiator include 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-styryl)-4,6-bis(trichloromethyl)-s-triazine, 2-p-phenyl-4,6-bis(trichloromethyl)-s-triazine, bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2-4-trichloromethyl(piperonyl)-6-triazine, and 2-4-trichloromethyl(4′-methoxystyryl)-6-triazine, and mixtures thereof.

Specific examples of suitable acetophenone compounds include 2,2′-diethoxyacetophenone, 2,2′-dibutoxyacetophenone, 2-hydroxy-2-methylpropiophenone, p-t-butyltrichloroacetophenone, p-t-butyldichloroacetophenone, benzophenone, 4-chloroacetophenone, 4,4′-dimethylaminobenzophenone, 4,4′-dichlorobenzophenone, 3,3′-dimethyl-2-methoxybenzophenone, 2,2′-dichloro-4-phenoxyacetophenone, 2-methyl-1-(4-(methylthio)phenyl)-2-morpholinopropan-1-one, 2-benzyl-2-dimethylamino-1-(4-morpholinophenyl)-butan-1-one, and mixtures thereof.

Specific examples of suitable benzophenone compounds include benzophenone, benzoylbenzoate, methyl benzoylbenzoate, 4-phenylbenzophenone, hydroxybenzophenone, acrylated benzophenone, 4,4′-bis(dimethylamino)benzophenone, 4,4′-bis(diethylamino)benzophenone, and mixtures thereof.

Specific examples of suitable thioxanthone compounds include thioxanthone, 2-chlorothioxanthone, 2-methylthioxanthone, isopropylthioxanthone, 2,4-diethylthioxanthone, 2,4-diisopropylthioxanthone, 2-chlorothioxanthone, and mixtures thereof. Specific examples of suitable benzoin compounds include benzoin, benzoin methyl ether, benzoin ethyl ether, benzoin isopropyl ether, benzoin isobutyl ether, benzyl dimethyl ketal, and mixtures thereof. In addition to these compounds, carbazole compounds, diketone compounds, sulfonium borate compounds, diazo compounds, and biimidazole compounds may be used in the present invention.

The photopolymerization initiator can be a triazine compound having a maximum absorption wavelength (λₘₐₓ) ranging from about 340 to about 380 nm.

Representative examples of the triazine compound have the following structures:

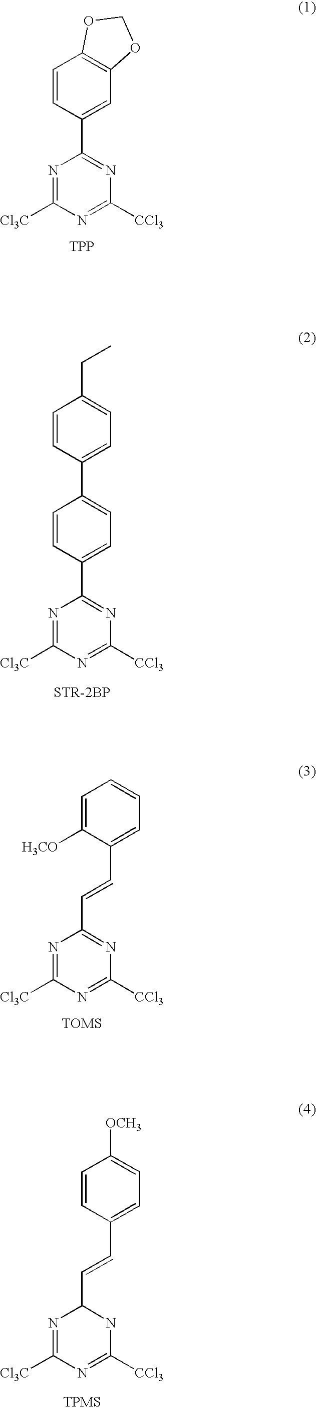

The amount of the photopolymerization initiator (c) can be from about 0.1 to about 10% by weight, based on the total weight of the final composition. When the photopolymerization initiator (c) is used in an amount of less than about 0.1% by weight, the monomers may not be sufficiently photopolymerized upon light exposure during formation of a pattern. Meanwhile, when the photopolymerization initiator is used in an amount exceeding about 10% by weight, the unreacted initiator remaining after photopolymerization can cause deterioration of transmittance.

The pigment dispersion (d) can be a solution in which a pigment, an acrylic dispersant and a dispersion of an acrylic resin having a carboxyl group are dispersed in a solvent. Exemplary pigments include red, green, blue, yellow and violet pigments. These pigments can be anthraquinone pigments, condensed polycyclic pigments (e.g., perylene pigments), phthalocyanine pigments, and azo pigments, which may be used alone or as a mixture thereof. A mixture of two or more pigments can be useful in terms of the adjustment of the maximum absorption wavelength, cross point and cross talk. The pigment can have a primary particle diameter of about 10 to about 70 nm. The use of the pigment having a primary particle diameter smaller than about 10 nm can cause poor stability of the dispersion, while the use of the pigment having a primary particle diameter larger than about 70 nm can unfavorably cause a deterioration in the resolution of pixels. The secondary particle diameter of the pigment is not especially limited, and can be smaller than about 200 nm taking into consideration the resolution of pixels.

The dispersant can be used to homogeneously disperse the pigment in the solvent. The dispersant may be any of a non-ionic, anionic or cationic dispersant. Specific examples of such dispersants include polyalkylene glycols and esters thereof, polyoxyalkylene, polyhydric alcohol esters, alkylene oxide adducts, alcohol alkylene oxide adducts, sulfonic acid esters, sulfonic acid salts, carboxylic acid esters, carboxylic acid salts, alkyl amide alkylene oxide adducts, and alkyl amines. These dispersants may be used alone or in any combination thereof. The combined use of the dispersant and the acrylic resin (a) can improve the stability of the pigment dispersion as well as improve the patternability of pixels. As the solvent, there may be used ethylene glycol acetate, ethyl cellosolve, propylene glycol methyl ether acetate, ethyl lactate, polyethylene glycol, cyclohexanone, propylene glycol methyl ether, or the like.

The pigment dispersion (d) can be used in an amount of about 0.1 to about 50% by weight, based on the total weight of the final composition. When the content of the pigment dispersion in the composition is lower than about 0.1% by weight, the coloration effects of the pigment may be negligible. Meanwhile, when the content of the pigment dispersion in the composition exceeds about 50% by weight, the developability of the composition can be considerably deteriorated.

As the solvent (e), there can be used, for example, ethylene glycol acetate, ethyl cellosolve, propylene glycol methyl ether acetate, ethyl lactate, polyethylene glycol, cyclohexanone, or propylene glycol methyl ether. These solvents may be used alone or as a mixture thereof. The solvent (e) can be used in an amount of about 20 to about 90% by weight, based on the weight of the final composition.

If needed, at least one additive selected from malonic acid, 3-amino-1,2-propanediol and fluorinated surfactants may be further added to the composition to prevent the formation of speckles and stains during coating, to control the leveling and to prevent occurrence of residue due to incomplete development of the composition. The content of the additive can be between about 0.1 and about 0.5% by weight, based on the total weight of the final composition.

The photosensitive resin composition for a color filter according to the present invention can be applied to a thickness of about 0.5 to about 1 μm to a wafer for a color filter of an image sensor. The application can be performed by an appropriate coating technique, e.g., spin coating or slit coating. After the application, light irradiation can be performed to form a pattern necessary to produce a color filter of an image sensor. I-line of 356 nm can be used as a light source for the irradiation. The coating layer can be developed with an alkaline developing solution to dissolve unexposed portions of the coating layer, thus completing the formation of a pattern necessary to produce a color filter of an image sensor. This procedure can be repeatedly carried out depending on the number of R, G and B colors to produce a color filter having a desired pattern. At this time, the pattern formed after the development may be additionally heated or cured by irradiation with actinic rays to further improve the physical properties, such as crack resistance and solvent resistance, of the color filter.

Hereinafter, the present invention will be explained in more detail with reference to the following examples. However, these examples are given for the purpose of illustration and are not to be construed as limiting the scope of the invention.

### EXAMPLES

### Example 1

| | |
|---|---|
| (1) Acrylic resin | 5 g |
| (A′)/(B′) = 25/75 (w/w), Molecular weight (M_{w}) = 25,000 | |
| (A′): Methacrylic acid | |
| (B′): Benzyl methacrylate | |
| (2) Photopolymerizable acrylic monomer | |
| Dipentaerythritol hexaacrylate (DPHA) | 4.1 g |
| (3) Photopolymerization initiator | |
| TPP (available from Ciba Specialty) | 0.2 g |
| (4) Pigment dispersion | 46.8 g |
| Red pigment (BT-CF, Ciba Specialty) | 6.2 g |
| Yellow pigment (2RP-CF, Ciba Specialty) | 2.8 g |
| Dispersant | 2.4 g |
| Dispersion of acrylic resin (the same as (1)) | 5.4 g |
| Solvent (PGMEA) | 30 g |
| (5) Solvents | |
| Propylene glycol monomethyl ether acetate | 20 g |
| Ethylethoxy propionate | 23.8 g |
| (6) Additive | |
| Fluorinated surfactant (F-475) | 0.1 g |

A photosensitive resin composition is prepared using the above components in accordance with the following procedure.

(1) Dissolve the photopolymerization initiator in the solvents (5), and stir the solution at room temperature for 2 hours.

(2) Add the acrylic binder resin having a carboxyl group and the photopolymerizable monomer to the solution, followed by stirring at room temperature for 2 hours.

(3) Add the pigment dispersion to the mixture obtained in step (2), followed by stirring at room temperature for one hour.

(4) Add the surfactant to the mixture obtained in step (2), followed by stirring at room temperature for one hour.

(5) Filter the mixture obtained in step (4) three times to remove impurities present therein.

The composition thus prepared is coated on a 6″-wafer using a spin coater (1H-DX2, manufactured by Mikasa) and dried at 100° C. for 180 seconds. The resulting structure is exposed to light using an I-line stepper (NSR i10C, Nikon, Japan) equipped with a reticle, in which patterns having various sizes are formed, for 250 ms, and developed with a 2.38% TMAH solution at room temperature for 120 seconds. The developed structure is cleaned and dried on a plate at a high temperature of 200° C. for 300 seconds to form a pattern. The pattern is observed under an optical microscope to determine the resolution of the pattern. The section of the pattern is observed by scanning electron microscopy (SEM). The coating thickness is measured using ST4000-DLX (KMAC). The results are summarized in Table 1.

### Examples 2 to 10

The procedure of Example 1 is repeated, except that acrylic copolymers having the acid value, the molecular weight and the monomer content shown in Table 1 are used and the kind of the photopolymerization initiator is varied as shown in Table 1. The results are summarized in Table 1.

### Comparative Examples 1 to 3

The procedure of Example 1 is repeated, except that an acrylic copolymer having a molecular weight and an acid value different from those of the acrylic copolymer used in the composition of Example 1 is used (Comparative Example 1), an oxime compound (Irgacure 369) is used as the photopolymerization initiator (Comparative Example 2), and a triazine compound (TR) having a low λₘₐₓ is used as the photopolymerization initiator (Comparative Example 3). The results are summarized in Table 1.

TABLE 1

| | | | | Photo- | | | | |
|---|---|---|---|---|---|---|---|---|
| | | | | polymerization | | | | |
| | Acrylic Resin (copolymer) | | | initiator | | Pixel pattern | | |
| | Monomer | Acid | Molecular | | λₘₐₓ | | | Resolution |
| | content | value | Weight | Kind | (nm) | Profile | Residue | (μm)* |
| Ex. 1 | Methacrylic | 100 | 25000 | TPP | 356 | ◯ | ◯ | 1 × 1 |
| | acid/benzyl | | | | | | | |
| | methacrylate (25/75) | | | | | | | |
| Ex. 2 | Methacrylic | 100 | 10000 | TPP | 356 | ◯ | Δ | 1 × 1 |
| | acid/benzyl | | | | | | | |
| | methacrylate (25/75) | | | | | | | |
| Ex. 3 | Methacrylic | 100 | 60000 | TPP | 356 | ◯ | Δ | 1.2 × 1.2 |
| | acid/benzyl | | | | | | | |
| | methacrylate (25/75) | | | | | | | |
| Ex. 4 | Methacrylic | 60 | 25000 | TPP | 356 | ◯ | ◯ | 1.4 × 1.4 |
| | acid/benzyl | | | | | | | |
| | methacrylate (18/82) | | | | | | | |
| Ex. 5 | Methacrylic | 130 | 25000 | TPP | 356 | ◯ | ◯ | 1 × 1 |
| | acid/benzyl | | | | | | | |
| | methacrylate (30/70) | | | | | | | |
| Ex. 6 | Methacrylic | 100 | 25000 | STR-2BP | 345 | ◯ | ◯ | 1 × 1 |
| | acid/benzyl | | | | | | | |
| | methacrylate (25/75) | | | | | | | |
| Ex. 7 | Methacrylic | 100 | 25000 | TOMS | 371 | ◯ | ◯ | 1 × 1 |
| | acid/benzyl | | | | | | | |
| | methacrylate (25/75) | | | | | | | |
| Ex. 8 | Methacrylic | 95 | 37000 | TPP | 356 | ◯ | ◯ | 1 × 1 |
| | acid/benzyl | | | | | | | |
| | methacrylate/ | | | | | | | |
| | methacrylate | | | | | | | |
| | (25/10/65) | | | | | | | |
| Ex. 9 | Methacrylic | 110 | 30000 | TPP | 356 | ◯ | ◯ | 1 × 1 |
| | acid/styrene/ | | | | | | | |
| | methacrylate | | | | | | | |
| | (25/20/55) | | | | | | | |
| Ex. 10 | Methacrylic | 120 | 39000 | TPP | 356 | ◯ | ◯ | 1.2 × 1.2 |
| | acid/styrene/2- | | | | | | | |
| | hydroxyethyl | | | | | | | |
| | acrylate/methacrylate | | | | | | | |
| | (25/20/15/40) | | | | | | | |
| Comp. | Methacrylic | 180 | 100000 | TPP | 356 | X | Δ | 5 × 5 |
| Ex. 1 | acid/benzyl | | | | | | | |
| | methacrylate (50/50) | | | | | | | |
| Comp. | Methacrylic | 100 | 25000 | Irgacure | 356 | X | Δ | 5 × 5 |
| Ex. 2 | acid/benzyl | | | 369 | | | | |
| | methacrylate (25/75) | | | | | | | |
| Comp. | Methacrylic | 100 | 15000 | TR | 327 | Δ | Δ | 3 × 3 |
| Ex. 3 | acid/benzyl | | | | | | | |
| | methacrylate (25/75) | | | | | | | |

Note:
*Resolution represents the smallest pixel size discernable

1) Evaluation of Profile

The section of the pixel patterns (1 μm×1 μm), which are formed using appropriate exposure doses, is observed by SEM. The profile of the patterns is evaluated based on the following criteria:

◯—Pixels are close to a square

Δ—Pixels are slightly round

×—Pixels are close to a circle

2) Residue

The section of the pixel patterns (1 μm×1 μm), which are formed using appropriate exposure doses, is observed by SEM. The patterns are evaluated based on the following criteria:

◯—No residue is left on unexposed portions

Δ—Residue is slightly left on unexposed portions

×—Residue is obviously observed on unexposed portions

As apparent from the above description, since the photosensitive resin composition of the present invention can enable the formation of ultra-fine pixels, it can be effectively used to produce color filters of high-resolution image sensors.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A photosensitive resin composition for a color filter, the composition comprising (a) an acrylic resin, (b) a photopolymerizable acrylic monomer, (c) a photopolymerization initiator, (d) a pigment dispersion and (e) a solvent wherein the acrylic resin comprises a copolymer of ethylenically unsaturated monomers and comprises about 10 to about 40 mole % of an ethylenically unsaturated monomer having a carboxyl group.

2. The photosensitive resin composition according to claim 1, wherein the photosensitive resin composition comprises (a) about 0.5 to about 20% by weight of the acrylic resin, (b) about 0.5 to about 20% by weight of the photopolymerizable acrylic monomer, (c) about 0.1 to about 10% by weight of the photopolymerization initiator, (d) about 0.1 to about 50% by weight of the pigment dispersion, and (e) the balance of the solvent.

3. The photosensitive resin composition according to claim 1, wherein the acrylic resin is a copolymer comprising as repeating units i) at least one ethylenically unsaturated monomer having a carboxyl group selected from the group consisting of acrylic acid, methacrylic acid, maleic acid, itaconic acid and fumaric acid, and ii) at least one ethylenically unsaturated monomer selected from the group consisting of styrenes; unsaturated carboxylic acid esters; unsaturated carboxylic acid aminoalkyl esters; carboxylic acid vinyl esters; unsaturated carboxylic acid glycidyl esters; vinyl cyanide compounds; and unsaturated amides.

4. The photosensitive resin composition according to claim 3, wherein:
said styrene is selected from the group consisting of styrene, α-methylstyrene, vinyltoluene and vinylbenzyl methyl ether;
said unsaturated carboxylic acid ester is selected from the group consisting of methyl acrylate, methyl methacrylate, ethyl acrylate, ethyl methacrylate, butyl acrylate, butyl methacrylate, 2-hydroxyethyl acrylate, 2-hydroxyethyl methacrylate, 2-hydroxybutyl acrylate, 2-hydroxybutyl methacrylate, benzyl acrylate, benzyl methacrylate, cyclohexyl acrylate, cyclohexyl methacrylate, phenyl acrylate and phenyl methacrylate;
said unsaturated carboxylic acid aminoalkyl ester is selected from the group consisting of 2-aminoethyl acrylate, 2-aminoethyl methacrylate, 2-dimethylaminoethyl acrylate and 2-dimethylaminoethyl methacrylate;
said carboxylic acid vinyl ester is selected from the group consisting of vinyl acetate and vinylbenzoate;
said unsaturated carboxylic acid glycidyl ester is selected from the group consisting of glycidyl acrylate and glycidyl methacrylate;
said vinyl cyanide compound is selected from the group consisting of acrylonitrile and methacrylonitrile; and
said unsaturated amide is selected from the group consisting of acrylamide and methacrylamide.

5. The photosensitive resin composition according to claim 1, wherein the acrylic resin comprises a copolymer of ethylenically unsaturated monomers and comprises about 20 to about 30 mole % of an ethylenically unsaturated monomer having a carboxyl group.

6. The photosensitive resin composition according to claim 1, wherein the photopolymerization initiator comprises an initiator selected from triazine compounds, acetophenone compounds, benzophenone compounds, thioxanthone compounds, and benzoin compounds.

7. The photosensitive resin composition according to claim 1, wherein the photopolymerization initiator comprises a triazine compound and has a maximum absorption wavelength (λₘₐₓ) of about 340 to about 380 nm.

8. The photosensitive resin composition according to claim 6, wherein the triazine compound comprises a compound represented by one of the following Formulae 1 to 4:

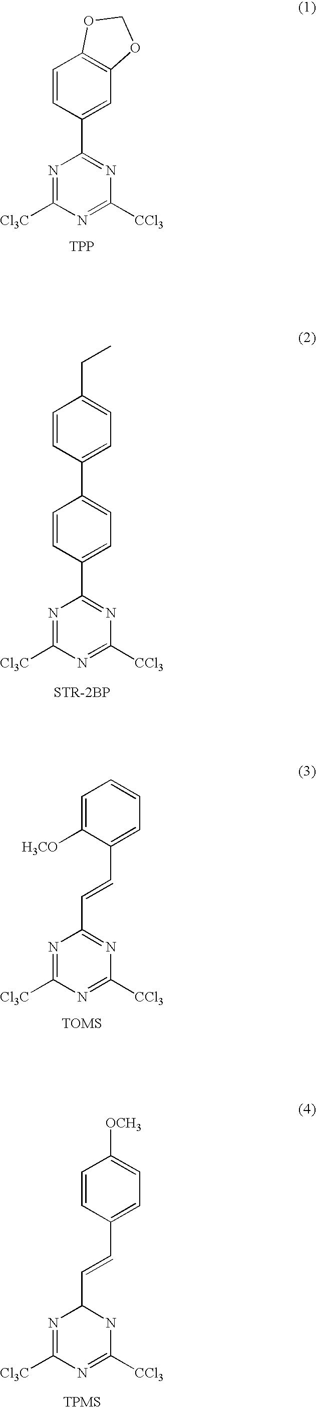

9. The photosensitive resin composition according to claim 1, further comprising at least one additive selected from malonic acid, 3-amino-1,2-propanediol, and fluorinated surfactants.

10. A color filter of an image sensor which comprises a pattern formed using the photosensitive resin composition according to claim 1.
